(19) United States
(12) Patent Application Publication
(10) Pub. No.: US 2007/0165279 A1
(43) Pub. Date: Jul. 19, 2007

(54) System and method for printing image and name of imaged landmark

(75) Inventors: Yosuke Ohashi, Saitama (JP); Hajime Terayoko, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 11/654,593

(22) Filed: Jan. 18, 2007

(30) Foreign Application Priority Data
Jan. 19, 2006 (JP) 2006-011584

(51) Int. Cl. G06K 15/00

(52) U.S. Cl. 358/1.18; 358/1.12

(57) ABSTRACT

In a printing system, a ROM stores map data that includes place data indicating names and locations of a variety of landmarks. Image data of each image includes position data indicating a camera location, at which the image is captured. When an image is chosen from thumbnail images on a display screen, a CPU searches the map data based on the position data of the chosen image. When a plural number of landmarks are retrieved for the chosen image, the CPU checks their relation of inclusion, and displays the names of the retrieved landmarks in such a sequence that one including a greater number of landmarks comes before. A printer section prints the chosen image and the names of the retrieved landmarks on a printing sheet, wherein the landmark names are printed in the displayed sequence at a designated position on a designated side of the printing sheet.

### FIELD OF THE INVENTION

The present invention relates to a system and a method for printing an image, which is shot by a camera, with the name of at least a landmark or place corresponding to the image.

### BACKGROUND OF THE INVENTION

In the field of digital cameras, it is getting popular to get position data, data of latitude and longitude, of a camera location from the GPS (Global Positioning System), and memorize the position data in association with captured image data. An exemplar of such a digital camera is a camera phone with a GPS receiver. Also, a device for deducing the name of an imaged place or landmark from the attached position data has been suggested.

Meanwhile, most of digital cameras stores captured image data in a storage medium, e.g. a memory card, so that captured images may be displayed on an LCD or the like based on the stored image data. Indeed the user of the digital camera can observe the captured image without the need for printing the image, and image data is superior to photo-prints in view of preservation properties, but, with regard to efficiency of sorting and searching the images, the image data is inferior to the photo-prints, because the photo-prints may be put in order by filing them into albums or the like.

Japanese Laid-open Patent Application No. 2001-36842 discloses an image processor, an image processing method and a storage medium, wherein based on data of a camera location corresponding to a captured image, several kinds of additional information relating to the camera location, such as information on sightseeing spots, are retrieved. When a desirable one is selected from among the several addition information, the selected additional information is superposed on the captured image, to print them together on a sheet.

Japanese Laid-open Patent Application No. 2002-281429 discloses a camera having title receiving function, a system and a method for transmitting and receiving image title and an electronic album. In the second prior art, each time a digital camera captures an image, it measures its position, latitude and longitude, and sends a requiring signal with the camera location data to a title server system. Upon receipt of the requiring signal, the title server system retrieves based on the camera location data a title relating to the camera location, and sends data of the retrieved title back to the digital camera. The digital camera memorizes the received title data in association with corresponding image data. The title data may be printed on the same side or back side of the captured image.

Although the above-mentioned prior arts permit selecting an appropriate one from among several place names or titles relating to the camera location, the place name data or the title data does not include any data on the relation of the named place to other places that may include, or be included in, or neighbor on the named place. Therefore, it is only possible to print a single place name or title together with the captured image.

### SUMMARY OF THE INVENTION

In view of the foregoing, a primary object of the present invention is to provide a system and a method for printing an image with a plural number of place or landmark names relating to the image.

According to the present invention, in a printing system for printing an image based on image data captured by a camera, wherein position data indicating a camera location, at which the image is captured, is written in or associated with the image data, the printing system comprises:

a map data storage device storing map data, the map data comprising place data indicating locations and names of a variety of places or landmarks located in a map area;

a search device that searches the map data based on the position data, to retrieve place data of at least a place or landmark that corresponds to the camera location; and

a printing device for printing the image and the name of the place or landmark as retrieved from the map data onto the same sheet of printing paper, wherein when a plural number of places or landmarks are retrieved for one image the printing device prints the names of the plural number of places or landmarks.

The printing device preferably prints the names of the plural number of places or landmarks in a sequence determined according to their relation of inclusion.

According to a preferred embodiment, the printing system further comprises:

a neighboring landmark display device for displaying names of neighboring places or landmarks which are located in the neighbor of the retrieved places or landmarks; and

an operating device that is externally operable to select one of the displayed neighboring places or landmarks, wherein the printing device prints the names of those places or landmarks selected by the operating device, instead of the names of the retrieved places or landmarks.

The neighboring landmark display device preferably displays the names of the neighboring places or landmarks in a sequence from the nearest to the retrieved places or landmarks.

Preferably, the printing system of the present invention further comprises a device for displaying a list of captured images, and a device for displaying one of the captured images in an enlarged size when the one image is chosen on the list, wherein the printing device prints the chosen image and the names of places or landmarks which correspond to the camera location of the chosen image.

More preferably, the printing system further comprises a device for deciding on which side and in which position of the printing paper the names of places or landmarks are to be printed.

The present invention also provides a method of printing at least a place name or landmark name in combination with an image, wherein position data indicating a camera location, at which the image is captured, is written in or associated with image data of the image, the method comprising steps of:

preparing map data comprising place data indicating locations and names of a variety of places or landmarks located in a map area;

obtaining the image data and the position data;

searching the map data based on the position data, to retrieve place data of at least a place or landmark that corresponds to the camera location; and

printing the image and the name of the place or landmark as retrieved from the map data onto the same sheet of printing paper, wherein when a plural number of places or landmarks are retrieved for one image, the names of the plural number of places or landmarks are printed in combination with the one image.

According to the present invention, when a plural number of places or landmarks are retrieved for one image, the printing device prints the names of the plural number of places or landmarks in combination with the image. As compared to a case where a single landmark name is printed with one image, it becomes easier to recognize the camera location, i.e., where the subject of the printed image is located.

By printing the names of the plural number of places or landmarks in a sequence determined according to their relation of inclusion, the recognition of the camera location becomes still easier.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram illustrating a digital camera and a printing system according to an embodiment of the present invention;

FIG. 2 is an explanatory diagram illustrating an example of an image listing screen displayed on a display device of the printing system;

FIG. 3 is an explanatory diagram illustrating an example of a landmark selection screen displayed on the display device of the printing system;

FIG. 4 is a plan view of a print made by the printing system;

FIG. 5 is an explanatory diagram illustrating another example of the landmark selection screen;

FIG. 6 is an explanatory diagram of map data;

FIG. 7 is an explanatory diagram of a map division data table;

FIG. 8 is an explanatory diagram of a divisional area index table;

FIG. 9 is an explanatory diagram of a landmark data table;

FIG. 10 is a plan view illustrating 2-D area data of a theme park;

FIG. 11 is a plan view illustrating 2-D area data of a Ferris wheel;

FIG. 12 is a plan view illustrating 2-D area data of a roller coaster;

FIG. 13 is a flow chart illustrating a sequence of operation of the printing system of the present invention; and

FIG. 14 is a block diagram illustrating a digital camera and a printing system according to another embodiment of the present invention.

### DESCRIPTION OF THE PREFERRED EMBODIMENTS

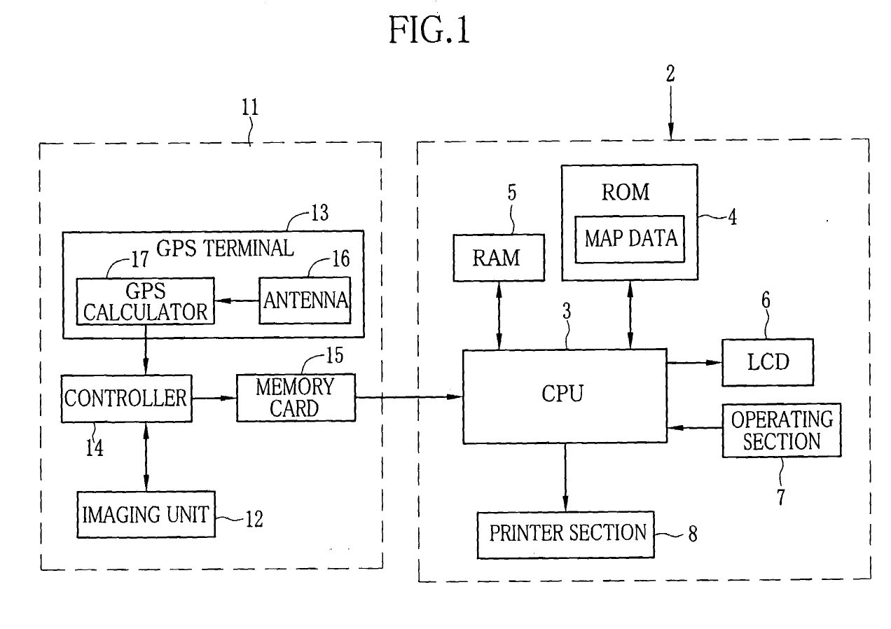

As shown in FIG. 1, a printing system 2 according to an embodiment of the present invention is constituted of a personal computer that is provided with a CPU 3, a ROM 4, a RAM 5, an LCD 6, an operating section 7, and a printer section 8. As described in detail later, the CPU 3 functions as a landmark search device, the ROM 4 functions as a map data memory, and the RAM 5 functions as an image data memory. The operating section 7 consists of a keyboard, a mouse and the like, and is operated to input data in the CPU 3. The printing system 2 prints images based on image data obtained from an external device, e.g. a digital camera 11.

The digital camera 11 is provided with an imaging unit 12 that comprises a shutter button and a taking lens in a conventional manner, a GPS terminal 13 for locating a present camera location and getting position data of the present camera location, and a controller 14. A memory card 15 for storing captured image data is detachably attached to the digital camera 11. The GPS terminal 13 has an antenna 16 and a GPS calculator 17. The antenna 16 is for receiving electric waves from a GPS satellite that is going around the earth. The received electric wave is sent to the GPS calculator 17, which stores a calculation program for calculating based on the electric wave the position data of the present camera location, i.e. latitude and longitude of the present camera location.

When an image is captured by operating the imaging unit 12, the controller 14 outputs a program activation signal to the GPS calculator 17, so the GPS calculator 17 activates the calculation program to calculate the position data, i.e. latitude and longitude of the present camera location, on the basis of the electric wave. Then the GPS calculator 17 sends the position data to the controller 14, so the controller 14 writes the position data from the GPS calculator 17 in the image data of the captured image, and thereafter writes the image data in the memory card 15.

To feed the image data from the memory card 15 to the printing system 2, the memory card 15 is taken out of the digital camera 11, and is inserted into a not-shown card slot of the printing system 2. Then the CPU 3 reads the image data from the memory card 15 and memorizes the image data in the RAM 5.

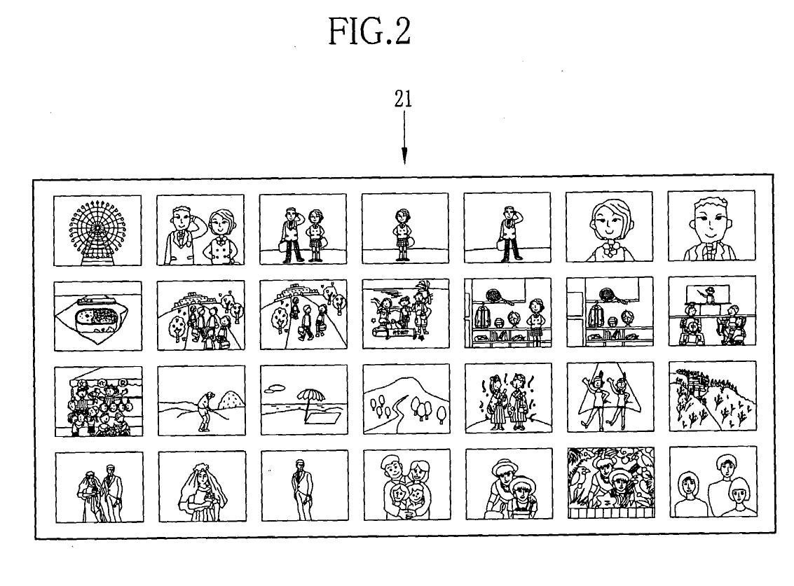

After the image data is read from the memory card 15 and written in the RAM 5, the CPU 3 drives the LCD 6 to display an image listing screen 21, on which thumbnail images are displayed as a list of the input image data, as shown in FIG. 2.

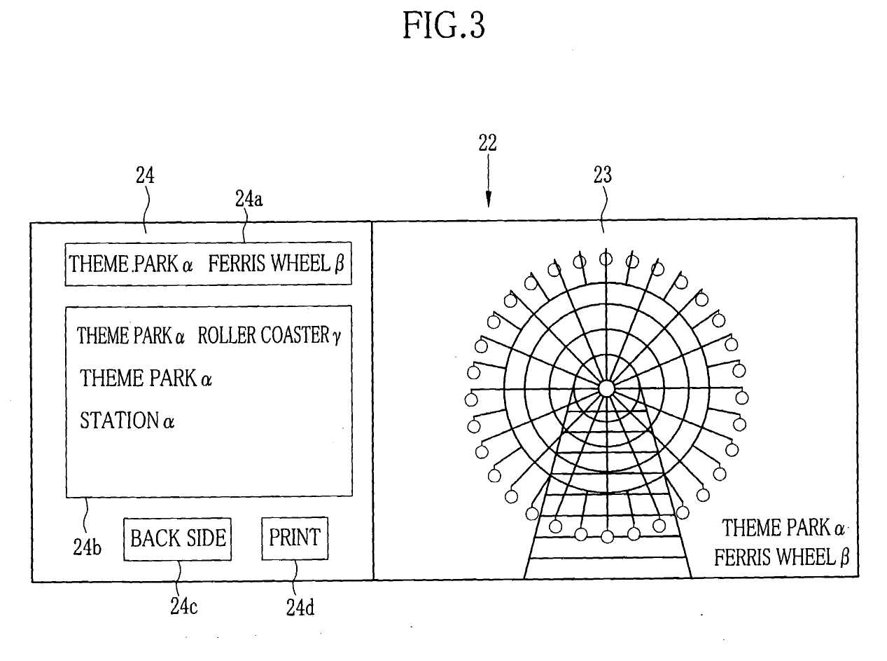

When an operator operates the operating section 7 to choose one of the thumbnail images on the image listing screen 21, the CPU 3 activates a landmark name search program, which is stored in the ROM 4, so a landmark selection screen 22 is displayed on the LCD 6, as shown in FIG. 3. The landmark selection screen 22 is provided with an image display section 23 and a print landmark name deciding section 24. The image display section 23 displays the chosen thumbnail image in an enlarged size. The image display section 23 may be provided with a size changing button for changing the display size of the image. The print landmark name deciding section is provided with a landmark name (LM name) display section 24a, a landmark name (LM name) selecting section 24b, a landmark name (LM name) printing side changing button 24c and a print button 24d.

According to the landmark name searching program, the CPU 3 searches map data of the ROM 4 for landmark names concerning the chosen image, based on the position data written in the image data of the chosen image. The results of searching are displayed in the LM name display section 24a, while the chosen image is displayed in the image display section 23, wherein the results show a relation of inclusion between the retrieved landmarks, as set forth in detail later. In the present example, “theme park a Ferris wheel β” is displayed in the LM name display section 24a, on the assumption that the position data of the chosen image represents a camera location inside a Ferris wheel β that is located in a theme park α.

The LM name selecting section 24b displays the names of neighboring landmarks which are located in the vicinity of the retrieved landmarks as displayed in the LM name display section 24a, wherein the neighboring landmark names are displayed sequentially from the nearest to the retrieved landmark. On the assumption that the theme park α is located in the neighbor of station α, and a roller coaster γ is located near the Ferris wheel β in the theme park α, the LM name selecting section 24b displays “theme park α roller coaster γ”, “theme park α” and “station α” in this order from the top, while the LM name display section 24a displays “theme park α Ferris wheel β”.

Thus, in the present embodiment, the LCD 6 functions as a device for displaying a list of captured images, a device for displaying a chosen image in an enlarged size, a device for displaying retrieved landmark names, a device for displaying neighboring landmark names, and a device for deciding landmark names to print.

The LM name printing side changing button 24c is for changing the side of printing paper 26 on which the landmark names as displayed in the LM name display section 24a, i.e. “theme park α Ferris wheel β” in this example, are to be printed. In default, “BACK SIDE” is displayed on the LM name printing side changing button 24c. Without operating the LM name printing side changing button 24c in this condition, the landmark names are printed on the front side of the printing paper 26, that is, on the same side as the image is printed. To print the landmark names on the back side of the printing paper 26, the LM name printing side changing button 24c displaying “BACK SIDE” thereon is operated by the operating section 7. Then the landmark names are set to be printed on the back side of the printing paper 26. When the LM name printing side changing button 24c is operated while it is displaying “BACK SIDE” thereon, the LM name printing side changing button 24c changes to display “FRONT” thereon. If the LM name printing side changing button 24c is operated in this condition, the landmark names are set to be printed on the front side of the printing paper 26. Thus, the landmark printing side is changed over each time the LM name printing side changing button 24c is operated.

When the back side of the printing paper 26 is selected for printing the landmark names, the image display section 23 stops displaying the captured image, and displays a condition of the back side of the printing paper 26. After it is decided on which side of the printing paper 26 the landmark names are to be printed, it is decided by operating the operating section 7 at which location of the printing paper 26 the landmark names are to be printed. In the illustrated example, the landmark names “theme park α Ferris wheel β” are set to be printed at a lower right position on the front side of the printing paper 26. Thus, the operating section 7 and the LM name printing side changing button 24c constitute a device for deciding the position of printing the landmark names. It is possible to provide buttons for changing the size and orientation, i.e. either vertical or horizontal arrangement, of the landmark names on the printing paper 26.

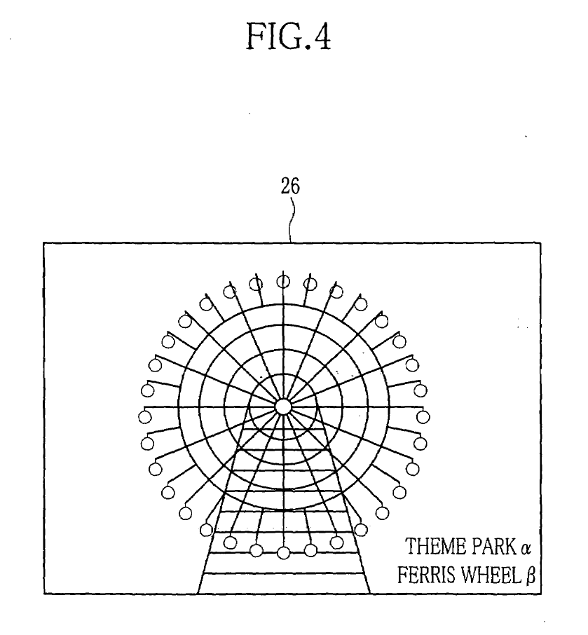

The printing button 24d is for starting printing the image as displayed in the image display section 23. Upon the printing button 24d being operated by the operating section 7, the printer section 8 prints the image and the landmark names, as displayed in the image display section 23, onto the printing paper 26, wherein the landmark names are printed in the same order as displayed in the LM name display section 24a. Namely, if a plural number of landmark names are retrieved, the most comprehensive one, i.e. “theme park α” in this example, is printed in the initial position, and the least comprehensive one, i.e. “Ferris wheel β”, is printed in the last position. Thus, the printing paper 26 having the image and the landmark names printed thereon is ejected from the printing system 2, as shown in FIG. 4.

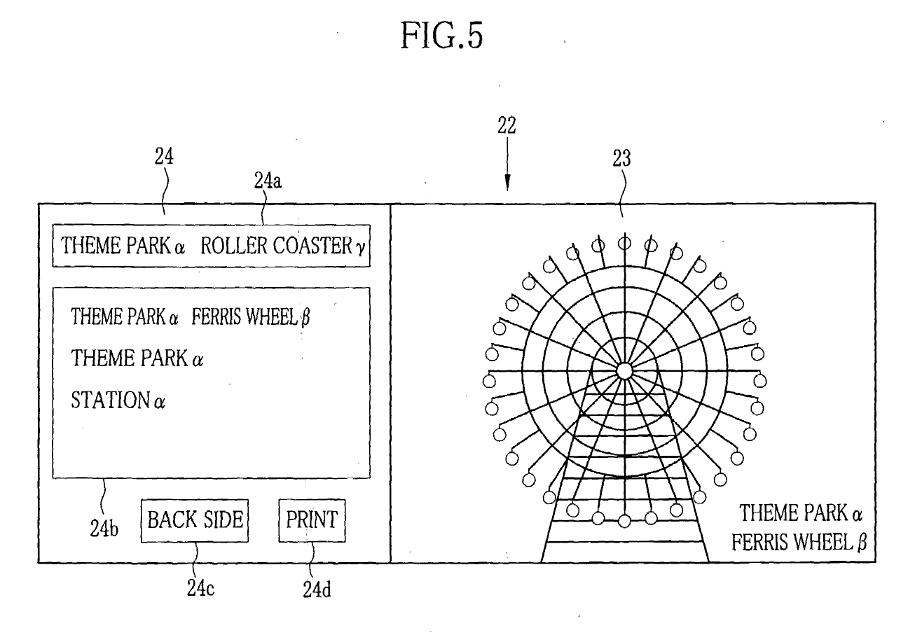

Meanwhile, since the GPS calculator 17 of the digital camera 11 calculates the position data of the present camera location based on the electric wave received on the antenna 16, the calculated position data cannot always exactly correspond to the captured image. If, for example, an image of the Ferris wheel β is captured by a photographer standing in the area of the roller coaster γ, the calculated position data indicate a position inside the area of the roller coaster γ, while the captured image contains the Ferris wheel β. In that case, the LM name data written in the image data of the captured image represents the roller coaster γ. When this image is chosen to be displayed on the image display section 23, “theme park a roller coaster γ” is displayed in the LM name display section 24a, while the enlarged image displayed on the image display section 23 contains the Ferris wheel β, as shown in FIG. 5. If the landmark names displayed in the landmark name display box 24a do not coincide with the image displayed on the image display section 23, it is necessary to correct the landmark names.

Then, the operator operates the operating section 7 to select a proper one of the landmark name options displayed in the LM name selecting section 24b. Then the selected landmark name or names are displayed in the LM name display section 24a. Simultaneously, the CPU 3 rewrites the LM name data of the chosen image with the selected landmark name or names, and then stores the rewritten image data of the chosen image in the RAM 5. In this example, the previous LM name data that is representative of “theme park α roller coaster γ” is rewritten with correct LM name data representative of “theme park α Ferris wheel β”.

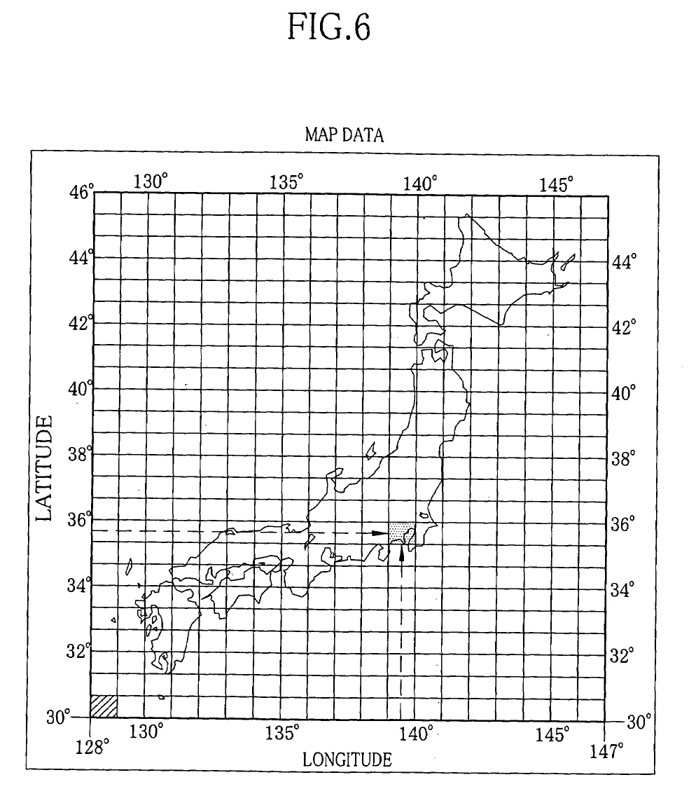

In the present embodiment, the map data stored in the ROM 4 is data of a schematic 2-D map of Japan, as shown in FIG. 6. The map expressed by the map data covers a map area having a start point at latitude 30° N and longitude 128° E, and an end point at latitude 46° N and longitude 147° E. The map data is divided at 1° interval of longitude and 40′ (⅔′) interval of latitude. In other words, the map area is divided into 456 (=19×24) divisional areas in the present embodiment.

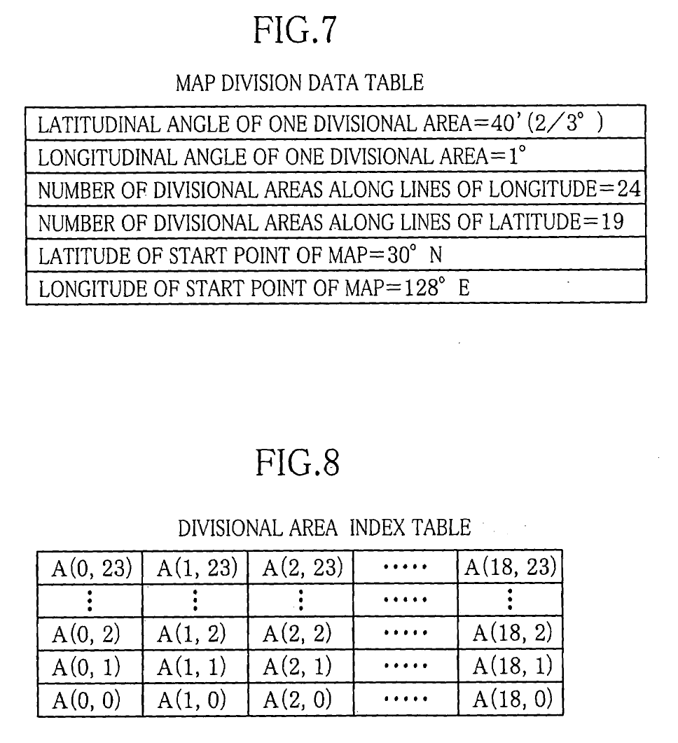

The map data is constituted of map division data table shown in FIG. 7 and divisional area index table shown in FIG. 8. The map division data table stores longitudinal and latitudinal angles of one divisional area, the number of divisional areas along lines of latitude, and the number of divisional areas along lines of longitude (meridians). The map division data table also stores latitude and longitude of the start point of the map. In the present embodiment, the longitudinal and latitudinal angles of one divisional area are 1° and ⅔°, respectively. The number of divisional areas along lines of latitude is 19, and the number of divisional areas along lines of longitude is 24. The latitude and the longitude of the start point are 30° N and 128° E, respectively.

The divisional area index table shown in FIG. 8 includes data of latitudes and longitudes of respective start points of all divisional areas. In FIG. 8, a couple of parenthetic numbers designate the place of each individual area relative to a start divisional area A(0,0) that is located at the start point of the map, the area hatched in FIG. 6. That is, the left parenthetic number of each area designates the number of order counted from the start area along latitude lines, whereas the right parenthetic number designates the number of order counted from the start divisional area A(0,0) along lines of longitude. For example, A(18,23) designates the divisional area including the end point of the map area, and A(10,15) designates the divisional area placed tenth from the start divisional area A(0,0) in the direction of latitude lines and fifteenth from the start divisional area A(0,0) in the direction of lines of longitude.

Although the map data is divided at 1° interval of longitude and at 40′ (⅔°) interval of latitude in the embodiment shown in FIGS. 6 to 8, this is for the sake of avoiding complication. In practice, the map data is to be divided more finely. For example, the divisional areas of the map preferably have a length of 10 km or so along latitude lines and along longitude lines as well. Correspondingly to the smaller size of the divisional areas, the number of divisional areas along lines of latitudes and along lines of longitude will increase.

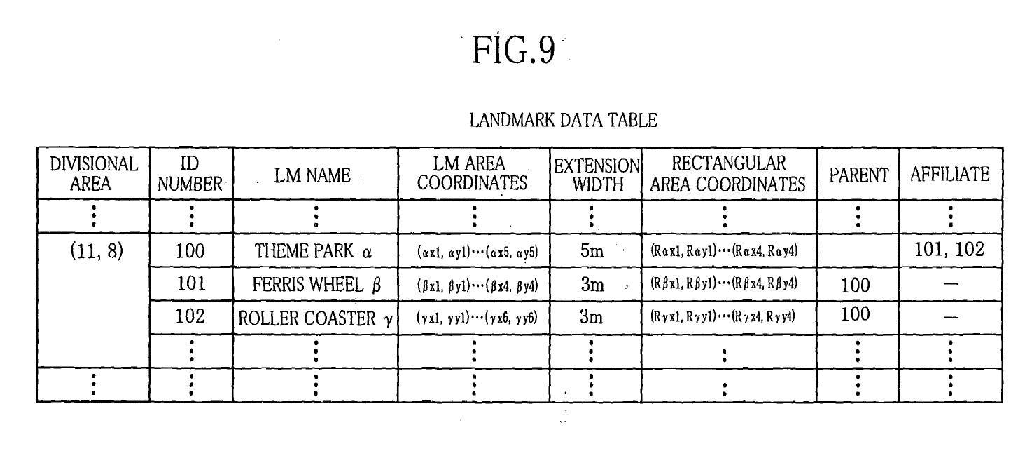

As shown in FIG. 9, the map data further include a landmark data table which stores place data, such as names of main landmarks, e.g. a theme park, a station and a school, which are located in the respective divisional areas, identification (ID) numbers assigned to the respective landmarks, area coordinates of the respective landmarks (LM area coordinates), extension widths, rectangular area coordinates, and parent data or affiliate data of the respective landmarks. In the present embodiment, an area A(11,8) will be described as an example where there is the theme park α, and the Ferris wheel β and the roller coaster γ are located in the theme park α.

The theme park a has an ID number #100, whereas the Ferris wheel β and the roller coaster γ have ID numbers #101 and #102 respectively. Since the Ferris wheel β and the roller coaster γ are located in the theme park α, they can be regarded as affiliates or subsidiaries of the theme park α in the relation of inclusion among the landmarks. Accordingly, the ID numbers #101 and #102 of the Ferris wheel β and the roller coaster γ are memorized in the affiliated data section of the theme park α, while the ID number #100 of the theme park α is memorized in the parent data sections of the Ferris wheel β and the roller coaster γ.

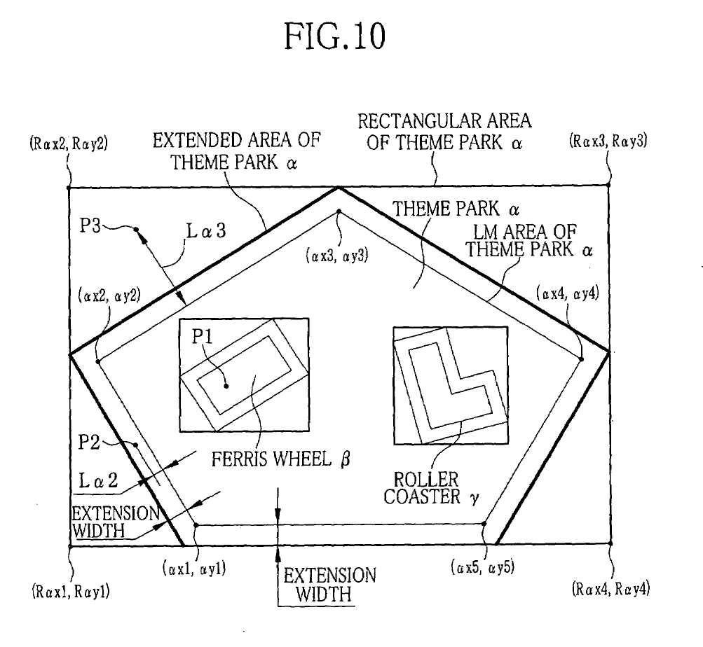

FIG. 10 shows area data of the theme park α schematically as a 2-D top plan view. The theme park α is a landmark having a pentagonal area, so data of coordinates (αx1, αy1), (αx2, αy2), (αx3, αy3), (αx4, αy4) and (αx5, αy5), which indicate respective latitudes and longitudes of the five vertexes, are memorized in the landmark area (LM area) coordinate section for the theme park α of the landmark data table, as shown in FIG. 9. The area bounded by lines extending between these vertexes may be called the landmark area of the theme park α. The area data further define an extended area of the theme park α, which is extended from the landmark area of the theme park α by a predetermined width in all directions. In the present example, the extension width from the landmark area to the extended area of the theme park α is 5 meters. Note that the extension width for each individual landmark is memorized in the extension width section of the landmark data table as shown in FIG. 9. Furthermore, the landmark data table includes data of a rectangular area of each landmark, or called a minimum bounding rectangle of each landmark, which circumscribes the extended area of each landmark. Specifically, data of coordinates indicating latitudes and longitudes of four vertexes of the rectangular area of the theme park α, i.e. (Rαx1, Rαy1), (Rαx2, Rαy2), (Rαx3, Rαy3) and (Rαx4, Rαy4) are memorized in the rectangular area coordinate section for the theme park α of the landmark data table, as shown in FIG. 9.

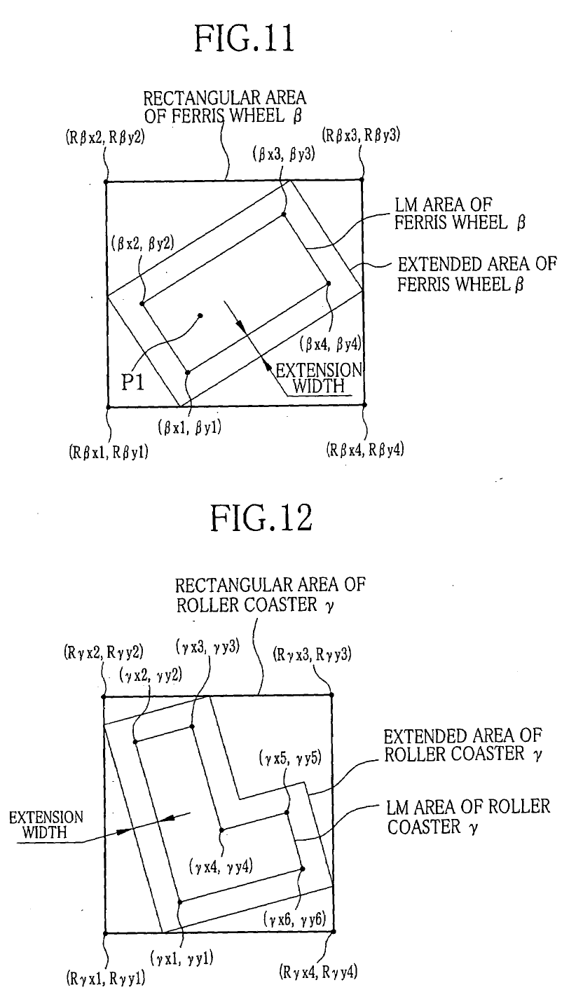

FIG. 11 shows area data of the Ferris wheel β schematically as a 2-D top plan view. The Ferris wheel β is a landmark having a rectangular area, so data of coordinates (βx1, βy1), (βx2, βy2), (βx3, βy3) and (βx4, βy4), which indicate respective latitudes and longitudes of the four vertexes, are memorized in the LM area coordinate section for the Ferris wheel β of the landmark data table as shown in FIG. 9. The area bounded by lines extending between these vertexes may be called the landmark area of the Ferris wheel β. The area data further define an extended area of the Ferris wheel β, which is extended by a predetermined width, e.g. 3 meters, in all directions from the landmark area of the Ferris wheel β. To define a rectangular area of the Ferris wheel β, which circumscribes vertexes of the extended area of the Ferris wheel β with latitudinal and longitudinal lines, data of coordinates indicating latitudes and longitudes of four vertexes of the rectangular area of the Ferris wheel β, i.e. (Rβx1, Rβy1), (Rβx2, Rβy2), (Rβx3, Rβy3) and (Rβx4, Rβy4) are memorized in the rectangular area coordinate section for the Ferris wheel β of the landmark data table as shown in FIG. 9.

FIG. 12 shows area data of the roller coaster γ schematically as a 2-D top plan view. The roller coaster γ is a landmark having a hexagonal area, so data of coordinates (γx1, γy1), (γx2, γy2), (γx3, γy3), (γx4, γy4), (γx5, γy5) and (γx6, γy6) which indicate respective latitudes and longitudes of the six vertexes, are memorized in the LM area coordinate section for the roller coaster γ of the landmark data table as shown in FIG. 9. The area bounded by lines extending between the six vertexes may be called the landmark area of the roller coaster γ. The area data further define an extended area of the roller coaster γ, which is extended by a predetermined width, e.g. 3 meters, in all directions from the landmark area of the roller coaster γ. To define a rectangular area of the roller coaster γ, which circumscribes vertexes of the extended area of the roller coaster γ with latitudinal and longitudinal lines, data of coordinates indicating latitudes and longitudes of four vertexes of the rectangular area of the roller coaster γ, i.e. (Rγx1, Rγy1), (Rγx2, Rγy2), (Rγx3, Rγy3) and (Rγx4, Rγy4), are memorized in the rectangular area coordinate section for the roller coaster γ of the landmark data table as shown in FIG. 12.

Referring back to FIG. 1, when the memory card 15 is connected to the CPU 3 of the personal computer 4, image data and associated position data are read out from the memory card 15 and input in the CPU 3. For example, the input position data designates a camera location P1 that is located at latitude 35.7° N and longitude 139.7° E. Then, the CPU 3 retrieves data from the map data of the ROM 4, to determine one divisional area that includes the camera location P1. Note that the memory card 15 is connected to the CPU 3 by taking the memory card 15 out of the digital camera 11 and inserting the memory card 15 into a not-shown memory card slot of the personal computer 4.

Specifically, in order to determine the divisional area that includes the entry position P1, the latitude of the start point of the map (=30° N) is reduced from the latitude of the camera location P1 (=35.7° N), and the value obtained by the reduction (=5.7°) is divided by the latitudinal angle of one divisional area (=⅔°). Then, decimal part of the quotient (=8.55) is rounded off: The numerical value (=8) obtained in this way indicates the number of order of the divisional area including the camera location P1, as counted along lines of longitude from the start divisional area A(0,0), the hatched area in FIG. 6. That is, the divisional area including the camera location P1 is determined to be one of the eighth areas from the start divisional area A(0,0) in the direction of lines of longitude.

Simultaneously, the longitude of the start point of the map (=128° E) is reduced from the longitude of the camera location P1 (=139.7° E), and the value obtained by the reduction (=11.7°) is divided by the longitudinal angle of one divisional area (=1°). Then, decimal part of the quotient (=11.7) is rounded off. The numerical value (=11) obtained in this way, indicates the number of order of the target divisional area as counted along lines of latitude from the start divisional area A(0,0). Consequently, the target divisional area including the camera location P1 is determined to be the area A(11,8) that is placed eleventh in the direction of latitude lines, and eighth in the direction of lines of longitude from the start divisional area A(0,0). Thus, the target divisional area including the camera location is determined by calculation based on the input position data, i.e. latitude and longitude of the camera location. This method saves time for searching the target divisional area including the camera location, in comparison with a case where the input position data are compared with all divisional areas of the map data on searching the target divisional area.

After the target divisional area is determined, the CPU 3 searches for a landmark relating to the camera location P1 with reference to the landmark data table. Since the camera location P1 is determined to be included in the divisional area A(11,8), the CPU 3 searches for merely those landmarks which are located in the area A(11,8). In the present example, the camera location P1 (35.7° N, 139.7° E) is assumed to be located at the Ferris wheel β in the theme park α, as shown in FIG. 6.

First, the CPU 3 retrieves at least a rectangular area that includes the camera location P1 among the rectangular areas of the landmarks located in the determined divisional area A(11,8). So the rectangular area of the theme park α, and the rectangular area of the Ferris wheel β are retrieved in this example.

Next, the CPU 3 calculates a distance Lα1 from the camera location P1 to the landmark area (LM area) of the theme park α, and a distance Lβ1 from the camera location P1 to the LM area of the Ferris wheel β. Concretely, the CPU 3 first judges whether a camera location P is inside or outside a LM area of a landmark, using a known method of judging whether a point is inside or outside a polygon. If the camera location P is inside the LM area, the distance L from the camera location P to the LM area is held to be zero. If not, the shortest distance from the camera location P to the LM area is decided to be the distance L. Since the camera location P1 is located at the Ferris wheel β in the theme park α, both the distance Lα1 from the camera location P1 to the LM area of the theme park α and the distance Lβ1 from the camera location P1 to the LM area of the Ferris wheel β are decided to be zero.

The landmark, of which the distance L from the camera location P is zero, is selected to be the landmark for the camera location P. Therefore, the theme park α and the Ferris wheel β(Lα1=0, Lβ1=0) are finally selected to be the landmarks for the camera location P1 (35.7° N, 139.7° E).

When a plural number of landmarks are finally selected for one camera location P, the CPU 3 checks the parent data sections and the affiliate data sections of these landmarks, i.e. the theme park a and the Ferris wheel β in this example, to determine the relation of inclusion between these landmarks and detect the number of landmarks included in each of the finally selected landmarks. Since the theme park α is a parent of the Ferris wheel β, the theme park α includes one landmark, whereas the Ferris wheel β includes no landmark. Then, the CPU 3 displays the names of the finally selected landmarks, i.e. the theme park α and the Ferris wheel β, in the LM name display section 24a of the landmark selection screen 22, in a sequence from the parent one to the affiliate one, i.e. such that one including a greater number of landmarks comes before, as shown in FIG. 3. Furthermore, the CPU 3 writes LM name data of the names of the finally selected landmarks in the image data, and thereafter writes the image data in the RAM 5. Instead of writing the LM name data in the image data, the LM name data and the image data may be memorized in association with each other.

Alternatively, in the case where a plural number of landmarks are finally selected for the camera location P1, it is possible to display the names of the finally selected landmarks in the LM name display section 24a of the landmark selection screen 22, sequentially in a sequence from the nearest to the camera location P1, i.e. “Ferris wheel β” first and “theme park α” next in this example.

If the input position data represents such a camera location that the distance from the camera location to any LM area of any landmark is not zero, the CPU 3 determines that the camera location is outside any LM areas of the determined divisional area. For example, if the input position data represent a camera location P2 that is located outside the theme park α but in the extended area of the theme park α, as shown in FIG. 10, the CPU 3 selects the theme park α as a landmark whose rectangular area includes the camera location P2. Next, the CPU 3 calculates a distance Lα2, that is the shortest distance from the camera location P2 to the LM area of the theme park α. Thereafter, the CPU 3 compares the distance Lα2 with the extension width for the theme park α, which is memorized in the extension width section for the theme park α of the landmark data table. If the distance Lα2 is not more than the extension width of the theme park α, the CPU 3 determines the theme park α to be the finally selected landmark, and outputs the LM name data of the theme park α to the LCD 6, to display “theme park α” in the LM name display section 24a of the landmark selection screen 22. Simultaneously, the CPU 3 writes the LM name data of the finally selected landmark, i.e. the theme park α in this example, in the image data, and thereafter writes the image data in the RAM 5.

If the input position data represent a camera location P3 that is located outside the extended area of the theme park α but in the rectangular area of the theme park α, as shown in FIG. 10, the CPU 3 selects the theme park α as a landmark whose rectangular area includes the camera location P3. Next, the CPU 3 calculates a distance Lα3, that is the shortest distance from the camera location P3 to the LM area of the theme park α. Thereafter, the CPU 3 compares the distance Lα3 with the extension width for the theme park α. Note that, if there are a number of landmarks whose rectangular areas include the camera location P3, only the distance L to the nearest landmark is compared with the extension width of the nearest landmark.

Because the distance Lα3 is more than the extension width of the theme park α, the CPU 3 does not determine the theme park α to be the finally selected landmark. That is, the camera location P3 is judged to be outside any landmark. In that case, the CPU 3 outputs data of a message that the camera location of this image is outside the main landmarks, to the LCD 6, to let the LCD 6 display this message. Simultaneously, the CPU 3 writes the data of this message in the image data, and thereafter writes the image data in the RAM 5.

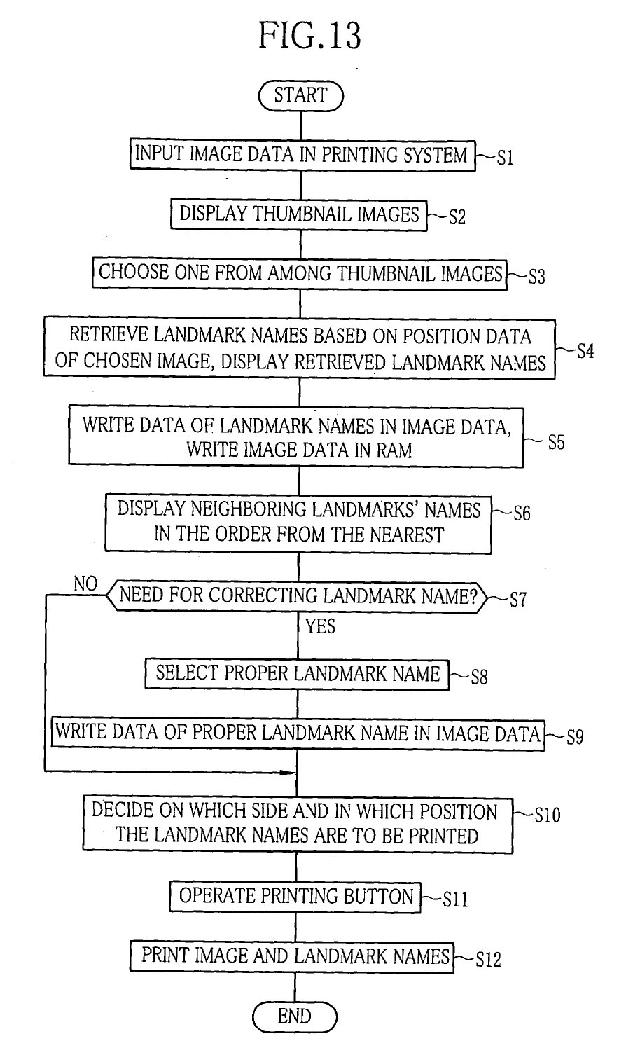

Now the operation of the printing system 2 will be described with reference to the flow chart of FIG. 13.

When the memory card 15 is connected to the CPU 3, the CPU 3 reads the image data from the memory card 15 and writes it in the RAM 5 (S1: step 1), and drives the LCD 6 to display thumbnail images of the read image data on the image listing screen 21 (S2: step 2).

When one of the thumbnail images is chosen on the image listing screen 21 by operating the operating section 7 (S3: step 3), the CPU 3 lets the chosen image displayed in the enlarged size in the image display section 23 of the landmark selecting screen 22. Simultaneously, the CPU 3 searches the map data of the ROM 4 based on the position data of the chosen image, for landmarks relating to a camera location designated by the position data, and displays the search results, the names of retrieved landmarks, in the LM name display section 24a (S4: step 4). For example, if the position data designates the camera location P1, that is located at latitude 35.7° N and longitude 139.7° E, the theme park a and the Ferris wheel β are selected as the search results, and are displayed in a sequence from the most comprehensive one to the least comprehensive one. Namely, a parent landmark is arranged before its affiliate landmark. Then, the CPU 3 writes data of finally retrieved landmark names in the image data, and thereafter writes the image data in the RAM 5 (S5: step 5).

Next, the CPU 3 displays in the LM name selecting section 24b a list of the names of the neighboring landmarks sequentially from the nearest to the landmarks whose names are displayed in the LM name display section 24a (S6: step 6). For example, as shown in FIG. 12, when “theme park α Ferris wheel β” are displayed in the LM name display section 24a, “theme park α roller coaster γ”, “theme park α” and “station α” are displayed in this order from the top in the LM name selecting section 24b.

The user checks the image displayed in the image display section 23 and the landmark names displayed in the LM name display section 24a to decide whether there is a need for correcting the landmark names or not (S7: step 7). If it is necessary to correct the landmark names, for example, where “theme park α and roller coaster γ” are displayed in the LM name display section 24a, while the Ferris wheel β is displayed in the image display section 23, the user selects a proper one or more of the landmark names displayed in the LM name selecting section 24b (S8: step 8). For example, “theme park α Ferris wheel β” are chosen in the LM name selecting section 24b. Then the CPU 23 rewrites the LM name data of the chosen image with the proper one, and thereafter rewrites the image data in the RAM 5 (S9: step 9).

Next, the user decides by operating the operating section 7 on which side and in which position the landmark names are to be printed (S10: step 10). If it is unnecessary to correct the retrieved landmark names, the printing system 2 skips the steps 8 and 9, and proceeds from the step 7 to the step 10.

Upon the printing button 24b being operated (S11: step 11), the printer section 8 starts printing the image as displayed in the image display section 23 on the printing paper 26, and also the retrieved or selected landmark names on the designated side in the designated position of the printing paper 26 (S12: step 12).

As described so far, if a plural number of landmarks are retrieved for a camera location of an image that is chosen to be printed, the retrieved landmarks are printed on the same printing paper 26 as the image. For example, if the Ferris wheel β of the theme park α is contained in the image, the printing system 2 can print the landmark names “theme park α Ferris wheel β” on the printing paper 26 together with the image. This configuration facilitates recognizing the camera location in comparison with a case where only one landmark name, e.g. “Ferris wheel β”, is printed with the image.

Because the plural number of landmarks are printed in a sequence from the most comprehensive one to the least comprehensive one, the recognition of the camera location is still more facilitated.

Furthermore, the user can choose between the front and back sides of the printing paper 26 for printing the landmark names, and also designate the printing position of the landmark names so as to fit them to the printed image.

Although the LM name selecting section 24b displays such landmarks that are located in the neighbor of the retrieved landmark or landmarks, which are retrieved based on the position data, as well as such landmarks that include the retrieved landmarks in their areas, it is possible to modify the concept of the neighboring landmarks that are to be displayed as options in the LM name selecting section 24b.

Although the image data and the position data as obtained from the GPS calculator 17 are stored in the memory card 15 in the above embodiment, it is possible to provide the digital camera 11 with a RAM, and store these data in this RAM.

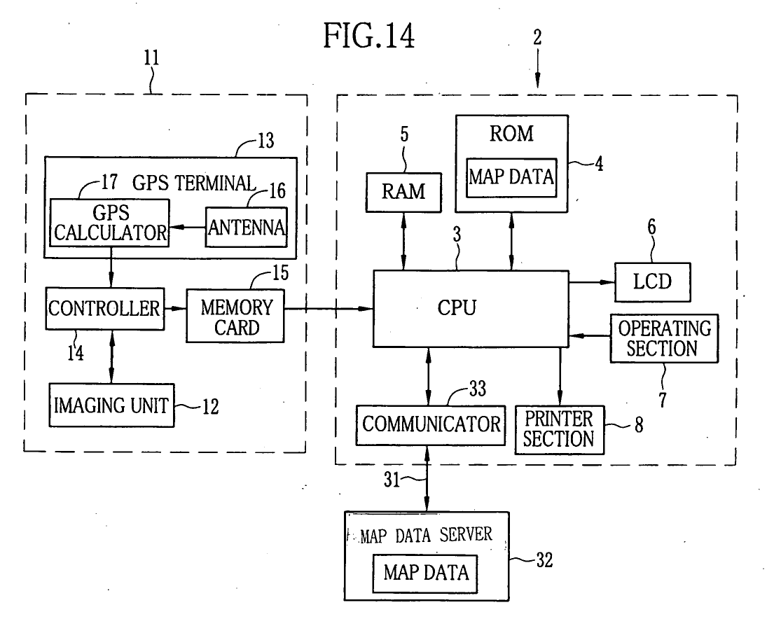

FIG. 14 shows a further embodiment of the present invention, wherein a printing system 2 is provided with a communicator 33 that is connectable to a map data server 32 through the Internet 31. The map data server 32 stores such map data as described in the above embodiment, and is installed in a map data managing organization or the like that manages the map data. The map data stored in the map data server 32 is always revised to be the latest ones.

According to this embodiment, the CPU 3 communicates with the map data server 32 through the communicator 33 and the Internet 31, and searches the map data of the map data server 32 based on position data of designated image data, to retrieve LM name data that correspond to the position data. Then the CPU 3 writes the retrieved LM name data in the designated image data, and then writes the image data on the ROM 5.

Since the printing system 2 of the embodiment of FIG. 14 is connectable to the map data server 32 through the communicator 33 and the Internet 31, to retrieve the LM name data relating to the position data of the image data from the latest map data stored in the map data server 32, the printing system 2 can identify the imaged landmarks without fail, even they are newly built ones.

Although the present invention has been described with respect to the preferred embodiments, the present invention is not to be limited to the above embodiments but, on the contrary, various modifications will be possible without departing from the scope of claims appended hereto.

What is claimed is:

1. A printing system for printing an image based on image data captured by a camera, wherein position data indicating a camera location, at which said image is captured, is written in or associated with said image data, said printing system comprising:
a map data storage device storing map data, said map data comprising place data indicating locations and names of a variety of places or landmarks located in a map area;
a search device that searches said map data based on said position data, to retrieve place data of at least a place or landmark that corresponds to the camera location; and
a printing device for printing said image and the name of the place or landmark as retrieved from said map data onto the same sheet of printing paper, wherein when a plural number of places or landmarks are retrieved for one image said printing device prints the names of said plural number of places or landmarks.

2. A printing system as claimed in claim 1, wherein said printing device prints the names of said plural number of places or landmarks in a sequence determined according to their relation of inclusion.

3. A printing system as claimed in claim 2, wherein the relation of inclusion between said plural number of places or landmarks is indicated by the retrieved place data.

4. A printing system as claimed in claim 1, further comprising a display device for displaying the names of the retrieved places or landmarks.

5. A printing system as claimed in claim 1, further comprising:
a neighboring landmark display device for displaying names of neighboring places or landmarks which are located in the neighbor of the retrieved places or landmarks; and
an operating device that is externally operable to select one of the displayed neighboring places or landmarks, wherein said printing device prints the names of those places or landmarks selected by said operating device, instead of the names of the retrieved places or landmarks.

6. A printing system as claimed in claim 5, wherein said neighboring landmark display device displays the names of the neighboring places or landmarks in a sequence from the nearest to the retrieved places or landmarks.

7. A printing system as claimed in claim 1 further comprising a device for displaying a list of captured images, and a device for displaying one of the captured images in an enlarged size when said one image is chosen on the list, wherein said printing device prints said chosen image and the names of places or landmarks which correspond to the camera location of said chosen image.

8. A printing system as claimed in claim 1, further comprising a device for deciding on which side and in which position of the printing paper the names of places or landmarks are to be printed.

9. A printing system as claimed in claim 1, further comprising an image data storage device for storing said image data and said place data in association with each other.

10. A printing system as claimed in claim 1, wherein said map data storage device is a ROM.

11. A printing system as claimed in claim 1, wherein said map data storage device is an external data server, and said printing system further comprises a communication device for communicating with said data server.

12. A method of printing at least a place name or landmark name in combination with an image, wherein position data indicating a camera location, at which said image is captured, is written in or associated with image data of said image, said method comprising steps of:
preparing map data comprising place data indicating locations and names of a variety of places or landmarks located in a map area;
obtaining said image data and said position data;
searching said map data based on said position data, to retrieve place data of at least a place or landmark that corresponds to the camera location; and
printing said image and the name of the place or landmark as retrieved from said map data onto the same sheet of printing paper, wherein when a plural number of places or landmarks are retrieved for one image, the names of said plural number of places or landmarks are printed in combination with said one image.

13. A method as claimed in claim 12, wherein the names of said plural number of places or landmarks are printed in a sequence determined according to their relation of inclusion.
